(19) United States
(12) Patent Application Publication
(10) Pub. No.: US 2014/0123482 A1
(43) Pub. Date: May 8, 2014

(54) OPTICAL FIBER CABLE PROCESSING APPARATUS

(71) Applicant: Sony Corporation, Tokyo (JP)

(72) Inventors: Fujio Kanayama, Kanagawa (JP); Tsuyoshi Ogawa, Kanagawa (JP); Kazuyoshi Yamada, Tokyo (JP); Shuichi Otaki, Kanagawa (JP)

(21) Appl. No.: 14/068,702

(22) Filed: Oct. 31, 2013

(30) Foreign Application Priority Data
Nov. 8, 2012 (JP) 2012-246767

(51) Int. Cl. G02B 6/245

(52) U.S. Cl. CPC G02B 6/245
USPC 29/795

(57) ABSTRACT

An optical fiber cable processing apparatus includes a rotation table (conveyance section) which conveys a case that houses an optical fiber cable obtained by coating an optical fiber, and to which a plurality of work stations is set. The rotation table includes a case holding part, and the case holding part includes a cable holding section that holds the optical fiber cable. Further, a pulling station at an upstream side includes a pulling section that pulls out the optical fiber cable from the case by a predetermined length and causes the cable holding section to hold the optical fiber cable, and the work stations at a downstream side perform necessary work with respect to the optical fiber cable held by the cable holding section. Processing of the optical fiber cable in each work station can be easily performed.

### CROSS REFERENCE TO RELATED APPLICATIONS

This application claims the benefit of Japanese Priority Patent Application JP 2012-246767 filed on Nov. 8, 2012, the entire contents of which are incorporated herein by reference.

### TECHNICAL FIELD

The present disclosure relates to an optical fiber cable processing apparatus, and to be more specific, relates to an optical fiber cable processing apparatus that performs necessary work with respect to an optical fiber cable housed in a case.

### BACKGROUND ART

In the past, an optical fiber cable having an optical fiber coated with a coating such as resin was known, and a work piece such as a substrate, a ferrule, or a connector is amounted to an end portion of the optical fiber cable.

When the work piece as described above is mounted to the optical fiber cable, first, the coating of the optical fiber cable is removed and the optical fiber is exposed, an end surface of the optical fiber is then cut into a necessary shape, and the work piece is mounted to the end surface of the optical fiber.

To conduct such work, an optical fiber cable processing apparatus disclosed in PTL 1 is known. The optical fiber processing apparatus includes a conveyance section that conveys a case that houses the optical fiber cable and in which a plurality of work stations is set along a conveying path of the case, and a processing section provided in each work station and which performs necessary work with respect to the optical fiber cable.

### CITATION LIST

### Patent Literatures

PTL 1: Japanese Patent No. 3301253

### SUMMARY

### Technical Problem

However, in the optical fiber cable processing apparatus disclosed in PTL 1, the optical fiber cable is wound in the case, and in each work station, the optical fiber cable is pulled out in order to perform processing, and the optical fiber cable is returned in the case after the processing.

Therefore, there is a problem that the optical fiber cable processing apparatus disclosed in PTL 1 needs to include a pulling section that pulls out the optical fiber cable to each work station and a returning section, and the structure of the apparatus becomes complicated and a cycle time becomes longer.

In view of such problems, the present disclosure provides an optical fiber cable processing apparatus that enables easy processing with respect to the optical fiber cable in each work station.

### Solution to Problem

An optical fiber cable processing apparatus according to an embodiment of the present disclosure includes: a conveyance section configured to convey a case housing an optical fiber cable obtained by coating an optical fiber with a coating material, and to which a plurality of work stations is set along a conveying path of the case; and a processing section provided in each work station, and configured to perform necessary work with respect to the optical fiber cable, wherein the conveyance section includes a case holding part that holds the case, and the case holding part includes a cable holding section that holds the optical fiber cable, one of the plurality of work stations is used as a mounting station that includes a work piece mounting section that mounts a work piece to a tip of the optical fiber cable, a work station at an upstream side than the mounting station is used as a pulling station that pulls out the optical fiber cable from the case by a predetermined length, and includes a pulling section that causes the cable holding section to hold the optical fiber cable, and the mounting station mounts a work piece to a tip of the optical fiber cable held by the cable holding section.

### Advantageous Effects of Invention

According to an embodiment of the present disclosure, a cable holding section that holds the optical fiber cable in a case holding part provided in the conveyance section is provided, and in a pulling station provided with a pulling section, the optical fiber cable is pulled out from the case by a predetermined length, and the optical fiber cable is held in the cable holding section.

As a result, in the work station at a downstream side, necessary work can be conducted with respect to the optical fiber cable held in the cable holding section without pulling out or returning the optical fiber cable again, and therefore, it is not necessary to provide the pulling section or the returning section in each work station.

In addition, the cable holding section is provided in the conveyance section instead of in the case body, and therefore, it becomes possible that a work piece mounting section in a mounting station is especially capable of mounting the optical fiber cable to the work piece based on a relative position relationship between the work piece mounting section and the cable holding section in the conveyance section without using a sensor and the like.

### BRIEF DESCRIPTION OF DRAWINGS

FIG. 1 is a plane view of an optical fiber cable processing apparatus 3 according to the present embodiment.

FIG. 2 is a side view of a case and a case holding part.

FIG. 3 is a cross sectional view of the III-III part of FIG. 2.

FIGS. 4(a) and 4(b) are front views of the case, in which FIG. 4(a) illustrates a state in which an optical fiber cable is held in the cable holding part and FIG. 4(b) illustrates a state in which a work piece is held in a work piece holding member.

FIG. 5 is an enlarged side view of a cable holding section.

FIG. 6 is a side view of a pulling station.

FIGS. 7(a) and 7(b) are side views illustrating a correcting station, in which FIG. 7(a) illustrates a temporary holding section and FIG. 7(b) illustrates a correcting section.

FIGS. 8(a) and 8(b) are diagrams illustrating a coating removal station, in which FIG. 8(a) is a side view and FIG. 8(b) is an enlarged view illustrating a coating removing process.

FIG. 9 is a side view illustrating a cleaning station.

FIG. 10 is a plane view illustrating a cleaning section.

FIGS. 11(a) and 11(b) are diagrams illustrating a cutting station, in which FIG. 11(a) is a side view and FIG. 11(b) is an enlarged view illustrating a cutting process.

FIGS. 12(a) and 12(b) are diagrams illustrating a mounting station, in which FIG. 12(a) illustrates a position confirmation state of the optical fiber and a work piece and FIG. 12(b) illustrates a mounted state of the work piece.

FIGS. 13(a) and 13(b) are diagrams illustrating a returning station, in which FIG. 13(a) illustrates a state in which the optical fiber cable is returned and FIG. 13(b) illustrates a state in which the work piece is held in the work piece holding member.

### DESCRIPTION OF EMBODIMENTS

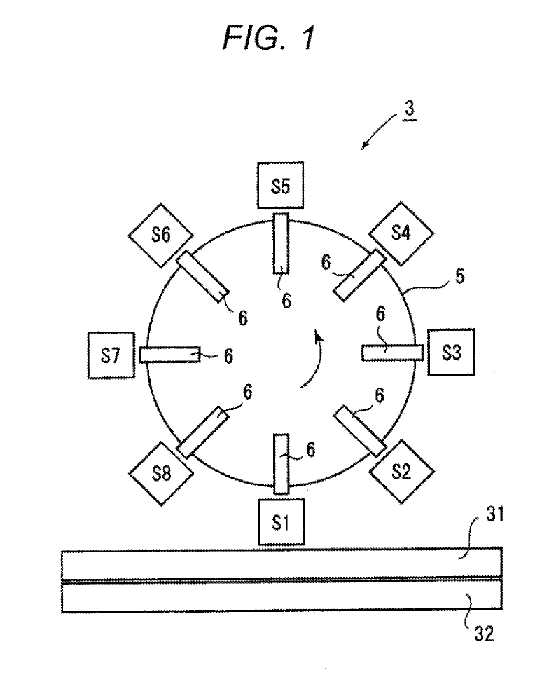

Embodiments in the drawings will be herein described. FIG. 1 illustrates a plane view of an optical fiber cable processing apparatus 3 in which a work piece 2 is mounted to a tip of an optical fiber cable 1.

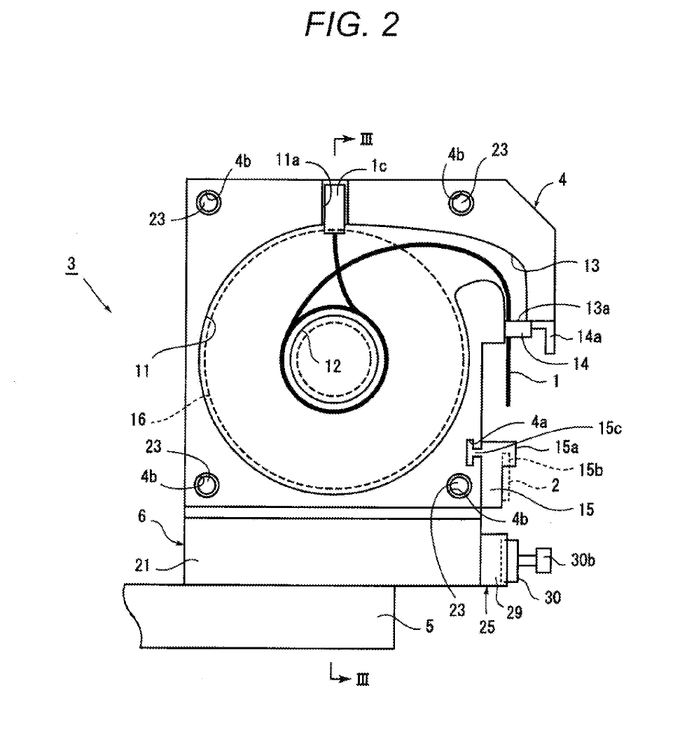

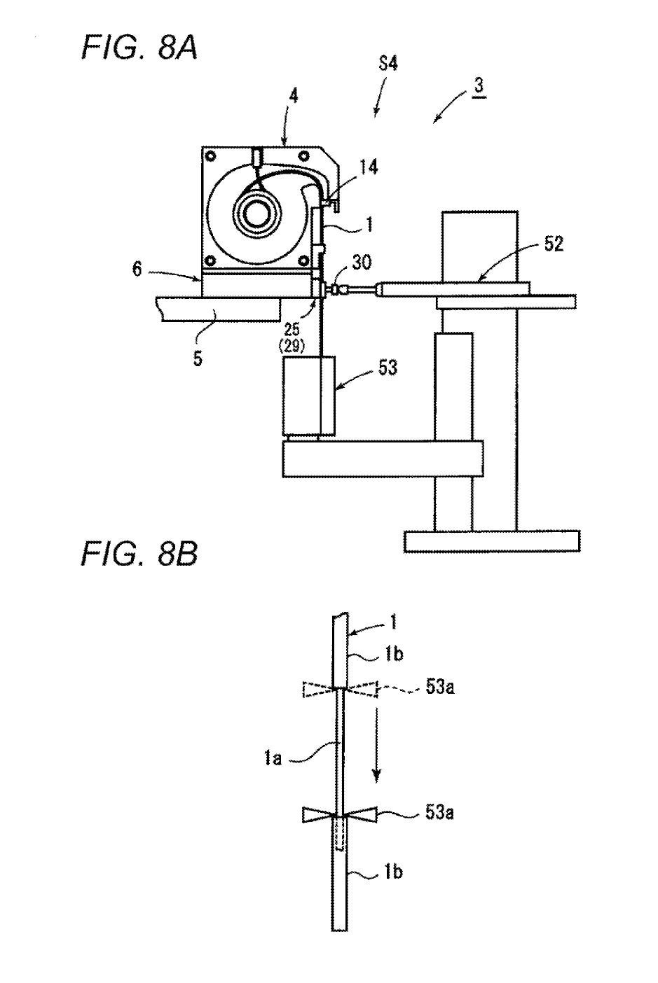

The optical fiber cable 1 has a structure in which the periphery of an optical fiber 1a is coated with a resin coating 1b (see FIG. 8(b)), and is supplied to the optical fiber cable processing apparatus 3 in a state in which the optical fiber cable 1 is wound inside a case 4 illustrated in FIG. 2.

A ferrule, a connector, an electronic substrate, or the like are corresponding to the work piece 2, and the work piece 2 in the present embodiment is an approximately rectangular plate-like electronic substrate and the optical fiber 1a is connected to an end portion of the electronic substrate.

In the optical fiber cable processing apparatus 3, the coating 1b at the tip of the optical fiber cable 1 is removed and the optical fiber 1a is exposed, an end surface of the exposed optical fiber 1a is cut into a necessary shape, and processing for connecting an end portion of the optical fiber 1a to the work piece 2 is then performed.

The optical fiber cable processing apparatus 3 includes a rotation table 5 as a conveyance section that conveys the case 4 and in which a plurality of work stations S is set along a conveying path of the case 4, and performs necessary work with respect to the optical fiber cable 1 in each work station S.

In FIG. 1, the rotation table 5 conveys the case 4 in a counterclockwise direction in the drawing. From the bottom end work station S in the drawing, a supplying/discharging station S1 that supplies/discharges the case 4 to/from the rotation table 5, a pulling station S2 that pulls out the optical fiber cable 1 from the case 4, a correcting station S3 that removes bending tendency of the optical fiber cable 1, a coating removal station S4 that removes the coating 1b at a tip portion of the optical fiber cable 1, a cleaning station S5 that cleans an exposed optical fiber 1a, a cutting station S6 that cut the end surface of the optical fiber 1a in a manner connectable to the work piece 2, a mounting station S7 that mounts the work piece 2 to the tip of the optical fiber 1a, and a returning station S8 that returns and houses the pulled-out optical fiber cable 1 in the case 4 are set.

The rotation table 5 includes eight case holding parts 6 corresponding to the work stations S1 to S8, and the rotation table 5 intermittently rotates with the interval of the case holding parts 6 as one pitch.

The case 4 will be described with reference to FIGS. 2 to 4. The case 4 is formed into an approximately rectangular parallelepiped, and a housing space 11 that houses the optical fiber cable 1, a core part 12 provided in the center of the housing space 11 and around which the optical fiber cable 1 is wound, and a guide space 13 formed adjacent to the housing space 11 and which guides the end portion of the optical fiber cable 1 into an outside part are formed inside the case 4.

Further, an opening/closing member 14 that opens/closes a guide slot 13a to hold the optical fiber cable 1 is provided in the guide slot 13a in the guide space 13, and a work piece holding member 15 that houses the work piece 2 mounted to the tip of the optical fiber 1a is provided below the guide slot 13a.

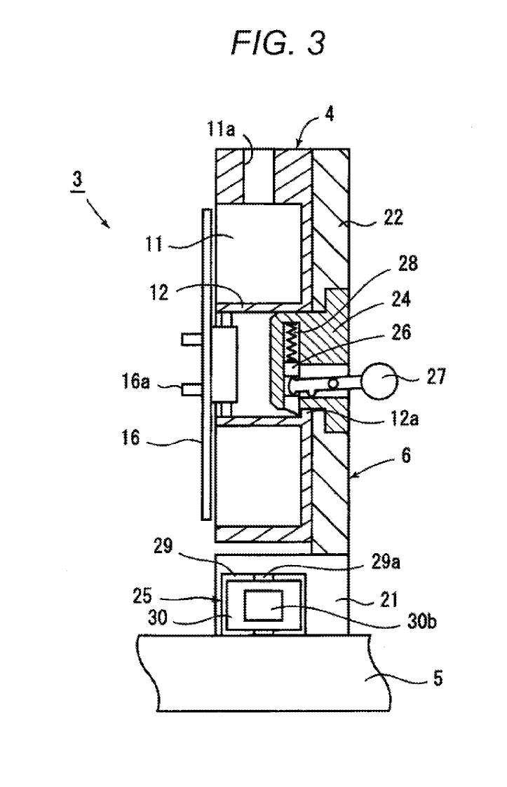

The housing space 11 is formed into an approximate circle. The optical fiber cable 1 is wound around the core part 12 and is housed inside the housing space 11, and a side surface on the left hand of the case 4 is open to an outside part as illustrated in FIG. 3.

One end of the optical fiber cable 1 housed in the housing space 11 is guided in the guide space 13 and is pulled out through the guide slot 13a to an outside, and the work piece 2 is mounted to the end portion of the optical fiber cable 1 exposed outside.

Further, the other end of the optical fiber cable 1 is housed in the housing space 11. A work piece 1c is mounted to the other end in advance, and is inserted into an insertion slot 11a from an inside, the insertion slot 11a being formed above the housing space 11, as illustrated in FIG. 2.

With such a structure, after the work piece 2 is mounted to the optical fiber cable 1 by the optical fiber cable processing apparatus 3 of the present embodiment, a device for a test and the like can be connected to the work piece 1c through the insertion slot 11a without taking the optical fiber cable 1 out of the case 4.

The core part 12 has a hollow cylindrical shape, and the optical fiber cable 1 is wound around the outer periphery. As illustrated in FIG. 3, both end parts of the core part 12 are open to outside. An insertion part 24 of the case holding part 6 described below is inserted into the opening part on the right hand of the core part 12 in the drawing, and a protrusion 12a engaged with an engagement protrusion 25 protruding from the insertion part 24 is formed on an inner periphery of the core part 12. Meanwhile, a lid member 16 that closes up the housing space 11 is mounted to the opening part on the left hand in the drawing, and the lid member 16 can be attached/detached to/from the case 4 by operating a lever 16a provided on an approximate center of the lid member 16.

The guide space 13 is continuously formed above the housing space 11 as illustrated in FIG. 2, and the guide slot 13a communicating with an outside part is formed to face downward. The optical fiber cable 1 is supplied such that the end portion thereof is hung more downward than the guide slot 13a.

The opening/closing member 14 that opens/closes the guide slot 13a is openable/closable into a closed state in which the opening/closing member 14 abuts on an outer surface of the case 4 and into an opened state in which the opening/closing member 14 is away from the outer surface. In the closed state, the opening/closing member 14 and the outer surface of the case 4 sandwich the optical fiber cable 1 to thereby prevent the optical fiber cable 1 from being pulling out from the case 4. An approximately L-shaped lever 14a is provided at a position adjacent to the opening/closing member 14, and the lever 14a is moved in a horizontal direction to cause the opening/closing member 14 to be in the closed state or in the opened state.

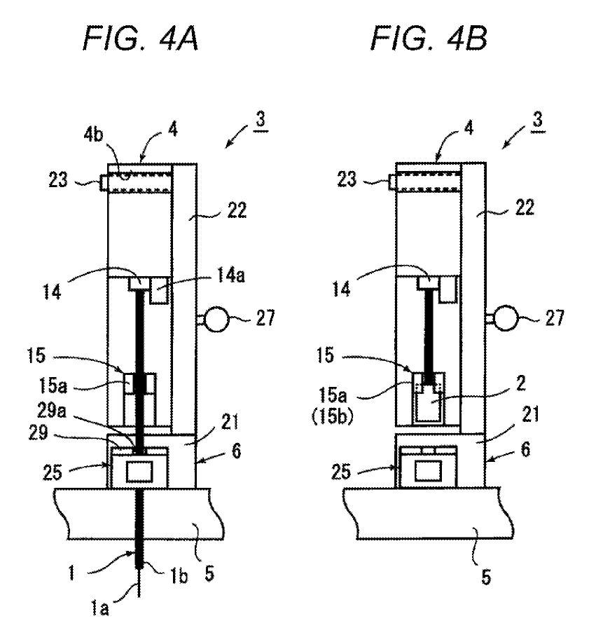

As illustrated in FIGS. 2 and 4, the work piece holding member 15 is fixed to an outside part of the case 4, positioned downside of the guide slot 13a in the guide space 13, and is formed to hold the work piece 2 at a position on an extended line of the optical fiber cable 1 hung down from the guide space 13.

Two protrusions 15a are formed on an end portion of the work piece holding member 15 at a side of the guide slot 13a, and the optical fiber cable 1 passes through between the protrusions 15a.

A recess portion 15b that houses a part of the work piece 2 is formed in the protrusion 15a on the side opposite to the guide slot 13a, and the end portion of the plate-like work piece 2 is housed in the recess portion 15b.

In holding, in the work piece holding member 15, the work piece 2 to which the optical fiber cable 1 is mounted with such a structure, it becomes possible that the work piece 2 does not fall out from the work piece holding member 15 if the opening/closing member 14 is caused in the closed state in a state in which the end portion of the work piece 2 is housed in the recess portion 15b.

Further, with regard to the work piece holding member 15 and the case 4, a T-shaped protrusion 15c formed on the work piece holding member 15 and a T-shaped recess portion 4a formed in the case 4 are fitted into each other, and the work piece holding member 15 can be easily attached/detached to/from the case 4 by moving the work piece holding member 15 into a depth direction in FIG. 2.

Therefore, when the type of the work piece 2 to be mounted to the optical fiber cable 1 is changed, it is possible to change the work piece holding member 15 to another corresponding work piece holding member 15.

Next, the case holding part 6 that holds the case 4 will be described. The case holding part 6 includes a base member 21 provided on the rotation table 5 at regular intervals, a plate-like side wall 22 standing upward from the base member 21, four support rods 23 protruding from the side wall 22, the approximately columnar insertion part 24 protruding from the side wall 22 and inserted into the core part 12 in the case 4, and a cable holding section 25 provided in the base member 21 and holding the optical fiber cable 1 in the case holding part 6.

As illustrated in FIG. 3, a gap is formed between an upper surface of the base member 21 and a lower surface of the case 4, and the side wall 22 is firmly attached to a right-hand side surface of the case 4 in the drawing. The support rods 23 are inserted into through holes 4b formed in four corners of the case 4 as illustrated in FIGS. 2 and 4, which prevent a rotation of the case 4 and determines the position of the case 4.

The insertion part 24 is a cylindrical member protruding toward the case 4 side and insertable into the core part 12, and a tip of the insertion part 24 is tapered, and an engagement protrusion 26 protruding from the inside to the outer periphery side of the insertion part 24 and a lever 27 for operating the engagement protrusion 26 are provided inside the insertion part 24. The engagement protrusion 26 is energized to protrude into an outside by a spring 28 elastically mounted inside the insertion part 24. When the case 4 is moved from the left hand of FIG. 3 toward the case holding part 6, the engagement protrusion 26 gets over the protrusion 12a of the inner center 12 and are engaged with each other, so that the case 4 is held to the case holding part 6 without falling out from the case holding part 6.

The lever 27 is swingably supported to the inside of the insertion part 24, and one end thereof protrudes from the end portion of the insertion part 24 on the side opposite to the case 4 at the side wall 22.

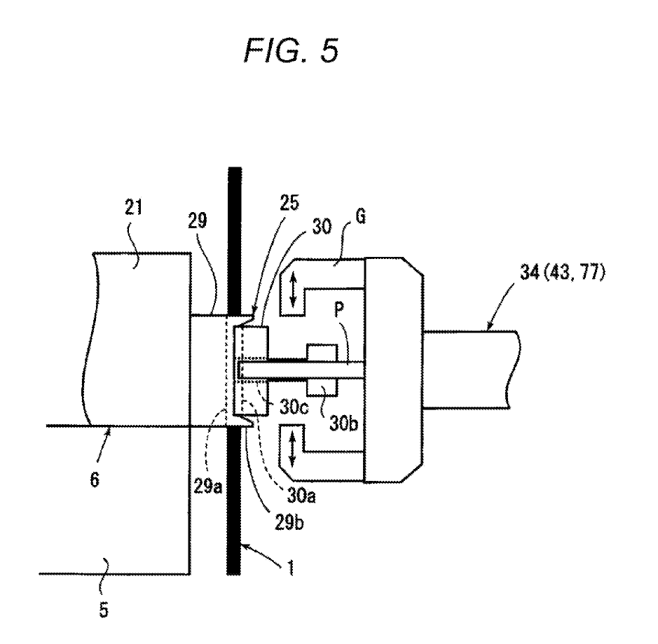

When the lever 27 is operated, the other end of the lever 27 allows the engagement protrusion 26 to retreat and recess inside the insertion part 24 against the energizing force of the spring 28, so that the engagement state between the engagement protrusion 26 and the protrusion 12a of the core part 12 is canceled and the case 4 can be detached from the case holding part 6. FIG. 5 illustrates an enlarged side view of the cable holding section 25. The cable holding section 25 includes a base 29 provided at the base member 21 and a cover 30 detachably provided to the base 29 by magnetic force of a magnet (not illustrated).

The base 29 is provided to protrude toward the outer periphery side with respect to the base member 21, and a surface facing the cover 30 is firmly attached to the cover 30, and is formed slightly larger than the cover 30.

Further, a groove 29a into which the optical fiber cable 1 fits is formed in the center of the base 29 in an up and down direction, and a tapered portion 29b inclining toward an inside is formed on an outer edge of the surface facing the cover 30.

The cover 30 is firmly attached to the base 29 when the cover 30 is fitted inside the tapered portion 29b formed on the base 29. A groove 30a is formed in the center in the up and down direction, and holds the optical fiber cable 1 between the groove 30a and the groove 29a in the base 29.

Further, in the cover 30, a knob 30b protrudes on the side opposite to the base 29, and a through hole 30c as a part to be engaged horizontally passing through the cover 30 is drilled in a position adjacent to the knob 30b.

The cover 30 is attached/detached to/from the base 29 by cover attaching/detaching sections 34, 43, and 77 provided in the pulling station S2, the correcting station S3, and the returning station S8.

The cover attaching/detaching sections 34, 43, and 77 of the work stations respectively include a gripper G that holds the knob 30b of the cover 30 and a pin P as an engagement part to be engaged with the through hole of the cover 30. The gripper G and the pin P are integrally moved by a device such as an air cylinder in each work station as described below.

First, when the cover 30 is detached from the base 29 by the cable holding section 25, the gripper G and the pin P approach the cover 30 from a side hand, and the pin P is inserted into the through hole 30c of the cover 30. Then, when the pin P is inserted and fully fitted into the through hole 30c, the gripper G holds the knob 30b and the gripper G is moved while keeping the holding state, the cover 30 is detached from the base 29 against the magnetic force.

At that time, the cover 30 is suppressed from the rotation by the engagement between the through hole 30c and the pin P, and the displacement of the cover 30 can be prevented while the gripper G holds the cover 30, accordingly.

Following that, when the optical fiber cable 1 is positioned in the vicinity of the groove 29a in the base 29, the gripper G approaches the base 29 and firmly attaches the cover 30 to the base 29 by the magnetic force of the magnet. At that time, the cover 30 is guided by a tapered portion 29b formed on the outer edge of the base 29, and is fitted with a predetermined position of the base 29.

Further, at that time, when the optical fiber cable 1 is pressed by the cover 30, the optical fiber cable 1 is sandwiched in a state of having been moved into the center of the grooves 29a and 30a of the base 29 and the cover 30. Therefore, the optical fiber cable 1 is held not to be shifted during being conveyed by the rotation table 5.

As described above, the cable holding section 25 is provided in the base member 21 that is fixed to the rotation table 5, whereby it becomes possible to handle the optical fiber cable 1 in each work station S based on a relative position between the optical fiber cable 1 and the cable holding section 25 when the rotation table 5 stops each case 4 at each work station S.

Hereinafter, each work station S will be described. First, the supplying/discharging station S1 will be described. As illustrate in FIG. 1, a supply conveyer 31 and a discharge conveyer 32 provided in parallel are provided in positions adjacent to the rotation table 5, and the supply conveyer 31 and the discharge conveyer 32 convey the case 4 from the left hand to the right hand of FIG. 1.

A transfer section (not illustrated) such as a robot hand is provided in the supplying/discharging station S1, and holds the case 4 conveyed by the supply conveyer 31 and mounts the case 4 on the case holding part 6 of the rotation table 5 positioned at the supplying/discharging station S1.

At that time, the transfer section moves the case 4 in the horizontal direction along the support rods 23 of the case holding part 6, and the side surface of the case 4 abuts on the side wall 22 and the engagement protrusion 26 of the insertion part 24 is engaged with the protrusion 12a of the core part 12 of the case 4, so that the case 4 is held in the case holding part 6.

Meanwhile, in the supplying/discharging station S1, when the processing in the returning station S8 is completed and the case 4 is conveyed to the supplying/discharging station S1 by the rotation table 5, the transfer section removes the case 4 from the case holding part 6 and places the case 4 on the discharge conveyer 32.

At that time, a lever operation section (not illustrated) operates the lever 27 of the case holding part 6 and causes the engagement protrusion 26 to retreat and recess inside the insertion part 24 to cancel the engagement state between the engagement protrusion 26 and the protrusion 12a of the core part 12, and in the state, the transfer section removes the case 4 from the case holding part 6 and places the case 4 on the discharge conveyer 32.

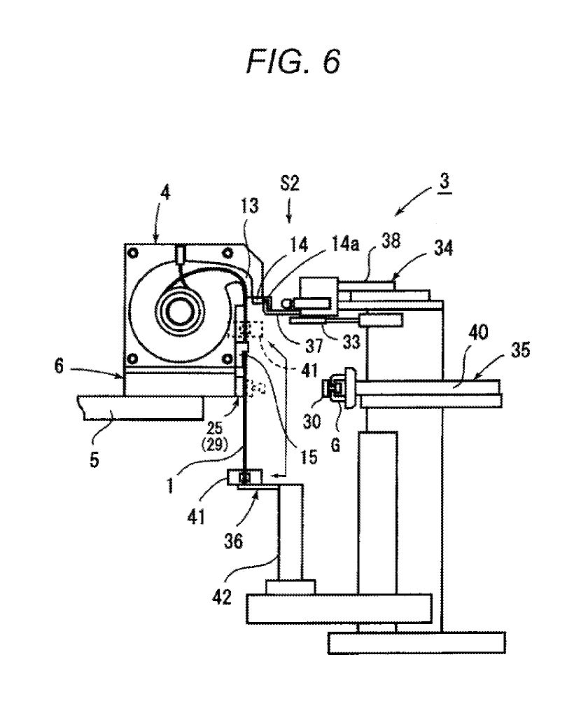

FIG. 6 is a diagram illustrating the pulling station S2. The pulling station S2 performs processing of pulling out the optical fiber cable 1 from the case 4, and causing the cable holding section 25 of the case holding part 6 to hold the tip portion of the optical fiber cable 1.

The pulling station S2 includes a sensor 33 that detects the optical fiber cable, an opening/closing member moving section 34 that causes the opening/closing member 14 of the case 4 to be in the opened state, a cover attaching/detaching section 35 that attaches/detaches the cover 30 of the cable holding section 25, and a pulling section 36 that pulls out the optical fiber cable 1 from the case 4 by a predetermined length.

The sensor 33 detects the optical fiber cable 1 hung downward from the guide slot 13a of the case 4 conveyed by the rotation table 5. If the sensor 33 cannot detect the optical fiber cable 1, a control section determines that the case 4 is a defective product, and omits the work in each work station in the downstream. The opening/closing member moving section 34 includes a hook 37 engaged with the lever 14a of the opening/closing member 14 of the case 4 and an air cylinder 38 that reciprocates the hook 37 in the horizontal direction.

The hook 37 stands by at an inner circumference side of the rotation table 5 than the lever 14a by the air cylinder 38 in advance, and when the case 4 arrives at the pulling station, the air cylinder 38 moves the hook 37 into an outer circumference side of the rotation table 5, so that the opening/closing member 14 becomes in the opened state from the closed state, and the optical fiber cable 1 can be pulled out.

The cover attaching/detaching section 35 includes a gripper 39 that holds the knob 30a of the cover 30 and an air cylinder 40 that moves the gripper 39 in the horizontal direction. When the air cylinder 40 moves the gripper 39 that holds the knob 30a, the cover 30 is detached against the magnetic force of the magnet provided between the cover 30 and the base 29.

The pulling section 36 includes a gripper 41 that holds the optical fiber cable 1 and a moving section 42 that moves the gripper 41.

First, the gripper 41 moved by the moving section 42 holds the optical fiber cable 1 hung down from the guide slot 13a of the case 4. At that time, the position of the optical fiber cable 1 may be recognized by a camera (not illustrated).

Following that, the opening/closing member moving section 34 causes the opening/closing member 14 of the case 4 to be in the opened state, so that the optical fiber cable 1 can be pulled out, and the cover attaching/detaching section 35 detaches the cover 30 from the base 29.

Then, the moving section 42 moves the tip of the optical fiber cable 1 to avoid the work piece holding member 15 positioned below the guide slot 13a and the base 29, and moves the tip to a lower part of the base 29. Accordingly, the optical fiber cable 1 is positioned in front of the base 29, and in the state, the cover attaching/detaching section 35 amounts the cover 30 to the base 29, so that the optical fiber cable 1 is sandwiched by the base 29 and the cover 30.

In this way, in the pulling station S2, the optical fiber cable 1 is pulled out from the case 4, and is held by the cable holding section 25 provided in the rotation table 5. Accordingly, each work station S positioned at the downstream side of the pulling station S1 can perform processing with respect to the optical fiber cable 1 held by the cable holding section 25.

That is, each work station S can recognize the position of the optical fiber cable 1 based on the position of the cable holding section 25, and a camera, a sensor, or the like for detecting the tip of the optical fiber cable 1 is not necessary in each work station S. Further, in each work station S, it is not necessary to pull out the optical fiber cable 1 from the case 4 in each time and to return the optical fiber cable 1 again after the processing, and it is not necessary to provide the pulling and returning sections in each work station and it becomes possible to reduce the cycle time in each work station.

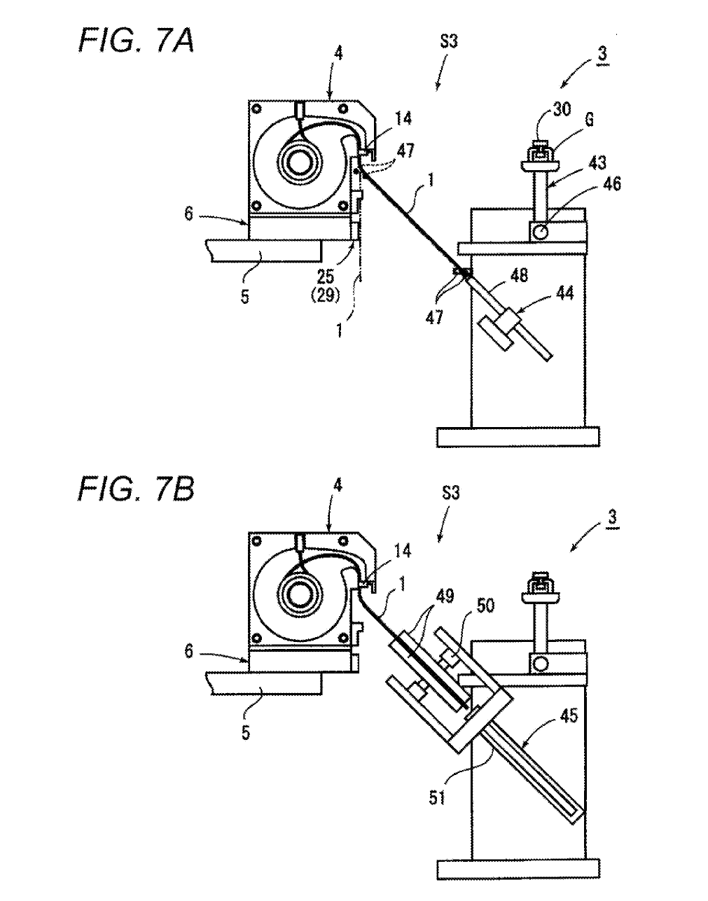

FIG. 7 is a diagram illustrating the correcting station S3. The correcting station S3 performs processing of removing the bending tendency of the optical fiber cable 1 pulled out from the case 4.

The optical fiber cable 1 is wound around the core part 12 in the case 4 supplied to the optical fiber cable processing apparatus 3. Therefore, the optical fiber cable 1 has so-called bending tendency, and the tip portion hung down to the outside part of the case 4 is not linear and the shape thereof is not uniform.

If the optical fiber cable 1 has the bending tendency, it is difficult to move the tip of the optical fiber 1a and the work piece 2 in a relative manner and to connect them. Therefore, the correcting station S3 corrects the bending tendency of the optical fiber cable 1 in advance.

The correcting station S3 includes the cover attaching/detaching section 43 that attaches/detaches the cover 30 of the cable holding section 25, a temporary holding section 44 (FIG. 7(a)) that temporarily and obliquely holds the optical fiber cable 1, and a correcting section 45 (FIG. 7(b)) that corrects the bending tendency of the optical fiber cable 1 pulled out from the case 4.

While detailed description of the cover attaching/detaching section 43 is omitted because it has a similar structure to the cover attaching/detaching section 35 provided in the pulling station S2, it is structured such that the cover 30 retreats by a swinging section 46 so that the temporary holding section 44 and the correcting section 45 do not interfere with the optical fiber cable 1.

The temporary holding section 44 is provided obliquely below the case holding part 6, and includes two guide bars 47 and a moving section 48 that moves the guide bars 47. The moving section 48 moves the guide bars 47 in an oblique direction and in a depth direction of FIG. 7.

First, when the case 4 is positioned at the correcting station S3, and the cover attaching/detaching section 43 removes the cover 30, the moving section 48 moves the guide bars 47 below the guide slot 13a in the case 4, and cause the optical fiber cable 1 to be positioned between the two guide bars 47.

Then, the moving section 48 moves the guide bars 47 obliquely downward, so that the optical fiber cable 1 is guided into the guide bars 47 and is temporarily obliquely held as illustrated in FIG. 7(a).

At this time, the guide slot 13a of the case 4 is in the closed state by the opening/closing member 14, and therefore, the optical fiber cable 1 is not pulled out from the case 4.

The correcting section 45 includes two plates 49 that sandwich the optical fiber cable 1, a heater (not illustrated) that heats the plates 49, and an opening/closing section 50 including an air cylinder that causes the plates 49 to be in contact with or to separate from each other.

The two plates 49 is provided to slope parallel with the optical fiber cable 1 temporarily and obliquely held by the temporary holding section 44, and can be moved by a moving section 51 that moves these plates 49. Further, although not illustrated, a linear groove is formed in the plate 49 positioned downward in the drawing, and a protrusion fitted into the groove is formed on the plate 49 positioned upward in the drawing. These plates at least have a length capable of sandwiching the vicinity of the cut portion of the optical fiber cable 1. When the moving section 51 moves the lower plate 49 in the drawing into a position below the optical fiber cable 1 held by the temporary holding section 44, the opening/closing section 50 causes the two plates 49 to approach each other and to sandwich the optical fiber cable 1 with the groove and the protrusion to deform the optical fiber cable 1 in a linear fashion.

In the state, when the heater heats the plates 49, the linear state of the optical fiber cable 1 is maintained in conjunction with the shapes of the groove and the protrusion, and the bending tendency is corrected. When the bending tendency is corrected in this way, the plates 49 release the optical fiber cable 1 by the opening/closing section 50 and retreat by the moving section 51. Accordingly, the optical fiber cable 1 is linearly hung down by its own weight.

The hung optical fiber cable 1 is positioned in front of the base 29 in the cable holding section 25. The cover attaching/detaching section 43 mounts the cover 30 to the base 29, so that the optical fiber cable 1 is held in the cable holding section 25 again.

Following that, the rotation table 5 can convey the optical fiber cable 1, the bending tendency of which has been corrected by the correcting section 45, to each work station S at the downstream side.

FIG. 8 is a diagram illustrating the coating removal station S4. The coating removal station S4 performs processing of removing the coating 1b from the tip of the optical fiber cable 1 to expose the optical fiber 1a.

The coating removal station S4 includes a pressing section 52 that presses the cover 30 of the cable holding section 25 and a coating removal section 53 that removes the coating 1b from the tip of the optical fiber cable 1. The pressing section 52 is structured to press the cover 30 of the cable holding section 25 from outside, and even if the optical fiber cable 1 is pulled by the coating removal section 53, the pressing section 52 holds the optical fiber cable 1 not to be unnecessarily pulled out from the case 4.

Since the coating removal section 53 is known, detailed description is omitted. As illustrated in FIG. 8(b), the coating removal section 53 includes a cutter 53a that moves along the outer periphery of the optical fiber cable 1 and cuts only the coating material 1b, and an elevating/lowering section (not illustrated) that elevates/lowers the cutter 53a and shifts the cut coating 1b downward along the optical fiber 1a.

The coating removal section 53 of the present embodiment allows the coating 1b to remain on the tip of the optical fiber 1a by shifting the cut coating 1b downward along the optical fiber 1a by a predetermined distance, and the optical fiber 1a is exposed between the separated coatings 1b.

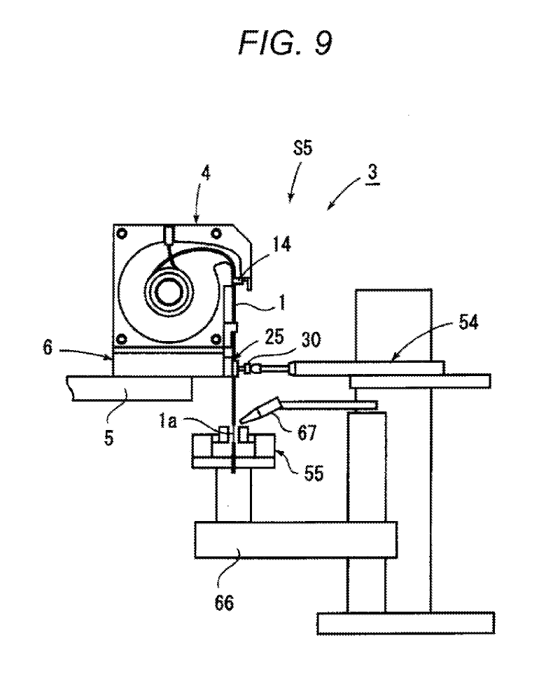

FIG. 9 is a diagram illustrating the cleaning station S5. The cleaning station S5 performs processing of removing fragments and the like attached to the exposed optical fiber 1a to clean the outer periphery of the optical fiber 1a.

The cleaning station S5 includes a pressing section 54 that presses the cover 30 of the cable holding section 25, and a cleaning section 55 that cleans the exposed optical fiber 1a.

The pressing section 54 holds, similarly to the coating removal station S4, the optical fiber cable 1 not to be unnecessarily pulled out from the case 4 by pressing the cover 30 while cleaning the optical fiber 1a by the cleaning section 55.

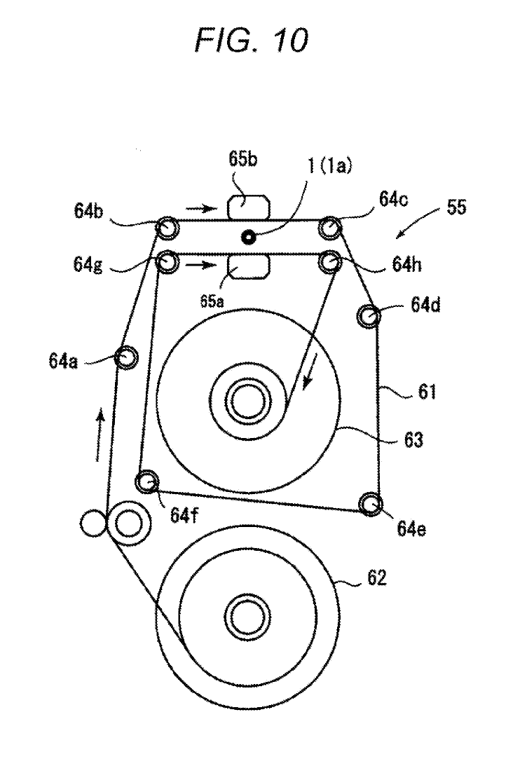

As illustrated in FIG. 10, the cleaning section 55 includes a supply role 62 that supplies a cleaning sheet 61 made of a nonwoven fabric or the like, a collecting role 63 that winds up the cleaning sheet 61, a plurality of guide rolls 64a to 64h provided between the supply role 62 and the collecting role 63 and provide on the path of the cleaning sheet 61, and a pair of pressing members 65a and 65b provided to sandwich the optical fiber 1a for each cleaning sheet 61. The cleaning section 55 is elevated/lowered by an elevating/lowering section 66 (see FIG. 9).

Further, an injection nozzle 67 (see FIG. 9) that injects a cleaning liquid such as an alcohol toward the cleaning sheet 61 positioned between the pressing members 65a and 65b is provided at a position adjacent to the cleaning section 55.

The cleaning sheet 61 sent out from the supply role 62 is arranged to pass through one side part and the other side part of the optical fiber 1a by the guide rolls 64a to 64h, and the pressing member 65 is provided at a more outside than the cleaning sheet 61 across the optical fiber 1a.

When the case 4 is positioned at the cleaning station S5 by the rotation table 5, and the pressing section 54 presses the cover 30 of the cable holding section 25, the whole cleaning section 55 is elevated by the elevating/lowering section 66, and the optical fiber 1a is positioned between the pair of pressing members 65a and 65b.

In this state, the injection nozzle 67 injects the cleaning liquid toward the cleaning sheet 61 positioned between the pressing members 65a and 65b, and then the pressing members 65a and 65b approach each other, so that the cleaning sheet 61 comes in contact with the outer periphery of the optical fiber 1a.

In this state, the elevating/lowering section 66 lowers the cleaning section 55, so that the outer periphery of the optical fiber 1a is wiped up by the cleaning sheet 61. At this time, the optical fiber cable 1 is not pulled out from the case 4 by the cover pressing section 54 pressing the cover 30 of the cable holding section 25.

When the cleaning of the optical fiber 1a is completed and the pressing members 65a and 65b are separated, the cleaning section 55 retreats below the optical fiber cable 1, and the supply role 62 and the collecting role 63 rotate and send out the cleaning sheet 61, so that the unused cleaning sheet 61 is positioned between the pressing members 65a and 65b.

Meanwhile, when the cleaning of the optical fiber 1a is completed and the cleaning section 55 retreats, the cover pressing section 54 is detached from the cover 30 of the cable holding section 25.

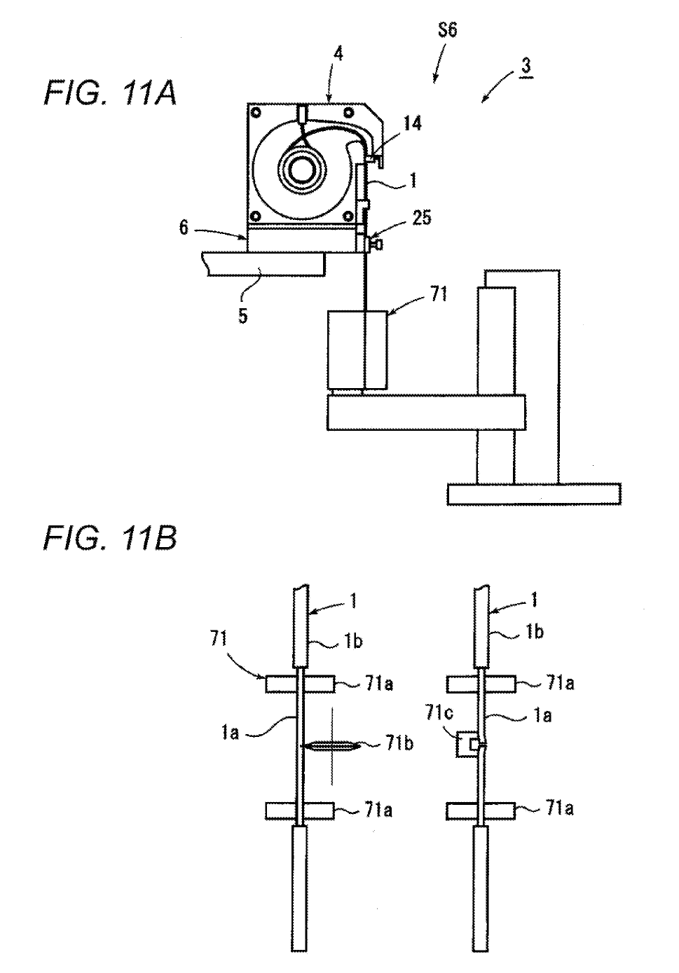

FIG. 11 is a diagram illustrating the cutting station S6. The cutting station S6 performs processing of cutting the optical fiber 1a and forming the end surface of the optical fiber 1a into a shape connectable with the work piece 2.

The cutting station S6 includes a cutting section 71 that cuts the optical fiber 1a. As illustrated in FIG. 11(b), the cutting section 71 includes a clamp 71a that holds upper and lower portions of the cutting position of the optical fiber 1a, a cutter 71b that forms a scratch in the outer periphery of the optical fiber 1a, and a cutting button 71c that presses the vicinity of the scratch to rupture the optical fiber 1a.

The cutter 71b forms the scratch in the surface of the optical fiber 1a by moving along the outer periphery of the optical fiber 1a. In the state, when the cutting button 71c presses the vicinity of the scratch, a crack is advanced from the scratch and the optical fiber 1a is raptured, and a necessary shape of the end surface can be obtained.

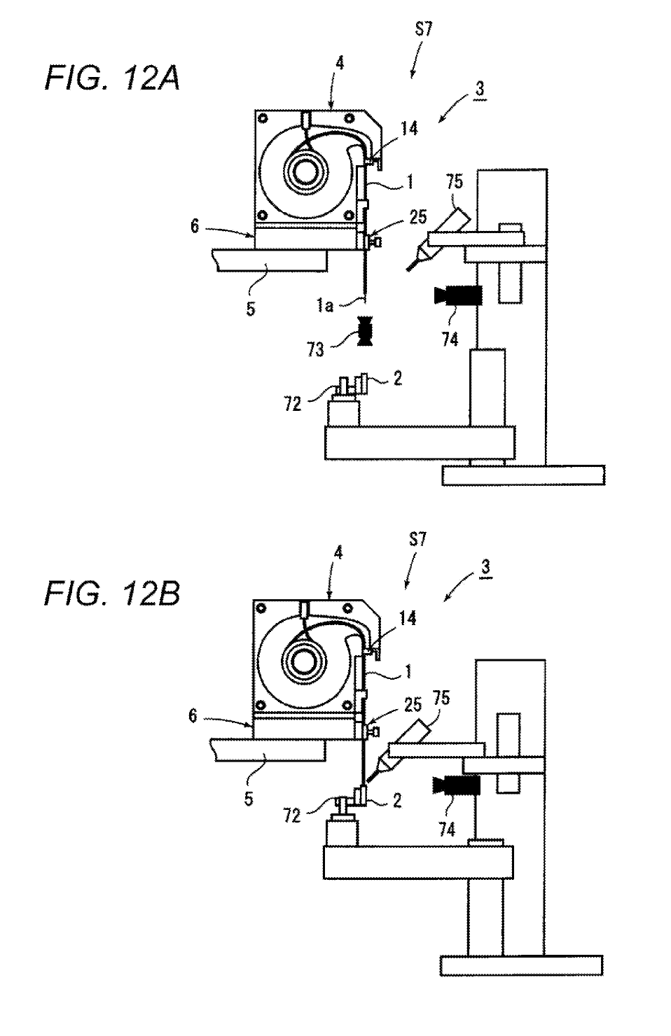

FIG. 12 is a diagram illustrating the mounting station S7. The mounting station S7 performs processing of mounting the work piece 2 to the end surface of the cut optical fiber 1a.

The mounting station S7 includes a work piece holding section 72 that holds the work piece 2, a first camera 73 and a second camera 74 that photograph the end surface of the optical fiber 1a and the work piece 2, and an adhesive supply section 75 that supplies an adhesive that glues the optical fiber 1a and the work piece 2.

The work piece holding section 72 can hold the work piece 2 supplied from a work piece supply section (not illustrated) such that a connection portion of the optical fiber 1a faces upward, move the work piece 2 in the horizontal direction and in the up and down direction, and rotate the work piece 2 on the horizontal surface. When the case 4 is positioned in the mounting station S7, the first camera 73 is moved into between the optical fiber cable 1 and the work piece 2 by a moving section (not illustrated) as illustrated in FIG. 12(a), and simultaneously photographs the up and down directions to thereby photograph a position of the end surface of the optical fiber 1a in the horizontal direction and a position of the connection portion of the fiber in the work piece 2 in the horizontal direction.

The second camera 74 is provided at a side of the optical fiber cable 1, and photographs the height of the end surface of the optical fiber 1a and the height of the connection portion of the fiber in the work piece 2, as illustrated in FIG. 12(b).

Images of these first and second cameras 73 and 74 are processed by a control section, and a positional relationship between the position of the end surface of the optical fiber 1a and the position of the connection portion of the optical fiber 1a in the work piece 2 is recognized, accordingly.

Then, the control section elevates the work piece 2 while moving the work piece 2 in the horizontal direction by the work piece holding section 72 and rotates the work piece 2 on the horizontal surface as needed to cause the connection portion of the optical fiber 1a in the work piece 2 to abut on a mounting position of the end surface of the optical fiber 1a (FIG. 12(b)).

The adhesive supply section 75 supplies an adhesive such as photocurable resin, for example. When the end surface of the optical fiber 1a abuts on the connection portion of the optical fiber 1a in the work piece 2, as illustrated in FIG. 12(b), the adhesive supply section 75 supplies the adhesive to an abutting portion and glues the portion.

In the present embodiment, the bending tendency of the optical fiber cable 1 is removed in the correcting station S3, and therefore, the end portion of the optical fiber 1a faces directly downward. By causing the work piece 2 to upwardly approach the optical fiber 1a, the work piece 2 and the optical fiber 1a can be mounted, whereby mounting failure can be prevented.

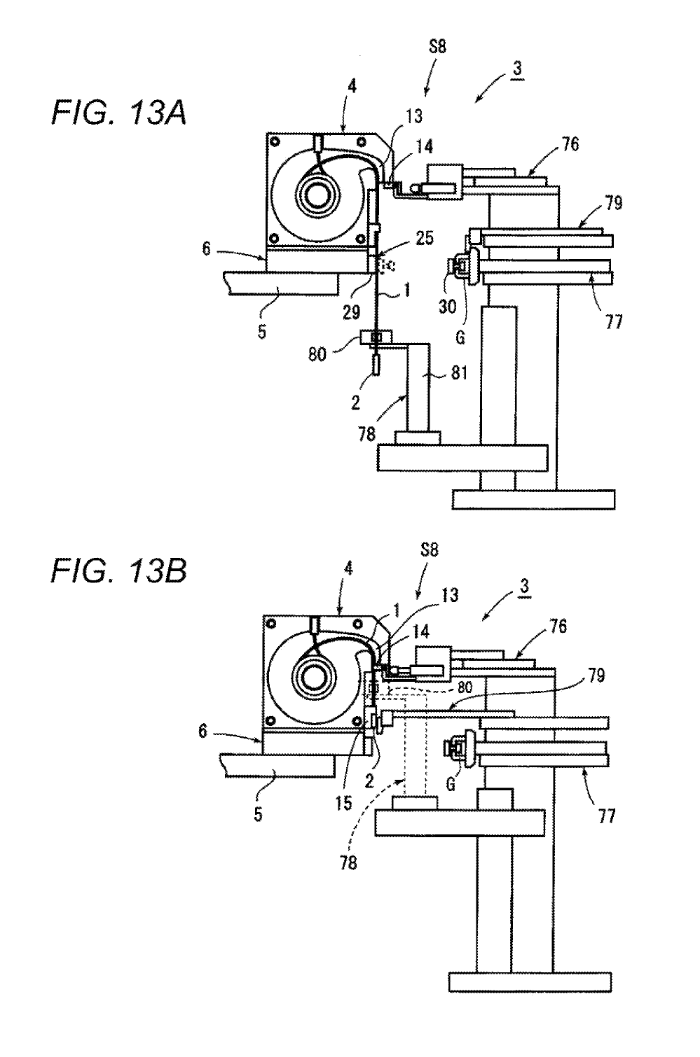

FIG. 13 is a diagram illustrating the returning station S8. The returning station S8 performs processing of returning the pulled-out optical fiber cable 1 to the case 4 and mounting the work piece 2 on the case 4. The returning station S8 includes an opening/closing member moving section 76 that moves the opening/closing member 14 of the case 4, the cover attaching/detaching section 77 that attaches/detaches the cover 30 of the cable holding section 25, a returning section 78 that returns the optical fiber cable 1 to the inside of the case 4, and a work piece attaching guide section 79 that causes the work piece holding member 15 to hold the work piece 2.

The opening/closing member moving section 76 and the cover attaching/detaching section 77 have structures common to the opening/closing member moving section 34 and the cover attaching/detaching section 35 of the pulling station S2, and therefore detailed description is omitted. When the case 4 is positioned at the returning station S8, the opening/closing member moving section 76 and the cover attaching/detaching section 77 operate to cause the opening/closing member 14 of the case 4 to be in the opened state, and to remove the cover 30 of the cable holding section 25.

The returning section 78 includes a gripper 80 and a moving section 81, similarly to the pulling section 35 of the pulling station S2. First, the gripper 80 holds the vicinity of the connection portion in the optical fiber cable 1 with the work piece 2 (FIG. 13(a)). Following that, the moving section 81 elevates the optical fiber cable 1 and moves the work piece 2 to the front of the work piece holding member 15 positioned below the guide slot 13a (FIG. 13(b)).

The work piece attaching guide section 79 is provided at the height of the work piece holding member 15 of the case 4, and when the work piece 2 is elevated in the vicinity of the work piece holding member 15, the work piece attaching guide section 79 abuts on the work piece 2 and moves the work piece 2 toward the side of the work piece holding member 15.

That is, when the returning section 78 moves the gripper 80 upward by the moving section 81, the work piece 2 abuts on the work piece attaching guide section 79 and is guided to approach the case side, and an upper end portion of the work piece 2 is fitted into the recess portion 15b of the work piece holding member 15. Following that, when the opening/closing member moving section 76 causes the opening/closing member 14 to be in the closed state, the work piece 2 is held to the recess portion 15b of the work piece holding member 15 without falling out from the recess portion 15b.

Then, the case 4 to which the work piece 2 is mounted is again conveyed to the supplying/discharging station S1 by the rotation table 5.

In the supplying/discharging station S1, the lever operation section (not illustrated) operates the lever 27 of the case holding part 6 to detach the engagement protrusion 26 of the insertion part 24 from the protrusion 12a of the core part 12. Following that, the moving section takes the case 4 out of the case holding part 6 and places the case 4 on the discharge conveyer 32. It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

1 Optical fiber cable
1a Optical fiber
1b Cover
2 Work piece
3 Optical fiber cable processing apparatus
4 Case
5 Rotation table
6 Case holding unit
11 Housing space
12 Core part
13 Guide space
13a Guide slot
14 Opening/closing member
23 Support rod
24 Insertion part
25 Cable holing section
29 Base
30 Cover
34 Opening/closing member moving section
35 Cover attaching/detaching section
36 Pulling section
45 Correcting section
78 Returning section
79 Work piece attaching guide section
S1 Supplying/discharging station
S2 Pulling station
S3 Correcting station
S4 Coating removal station
S5 Cleaning station
S6 Cutting station
S7 Mounting station
S8 Returning station

What is claimed is:

1. An optical fiber cable processing apparatus comprising:
a conveyance section configured to convey a case housing an optical fiber cable obtained by coating an optical fiber with a coating material, and to which a plurality of work stations is set along a conveying path of the case; and
a processing section provided in each work station, and configured to perform necessary work with respect to the optical fiber cable,
wherein the conveyance section includes a case holding part that holds the case, and the case holding part includes a cable holding section that holds the optical fiber cable,
one of the plurality of work stations is used as a mounting station that includes a work piece mounting section that mounts a work piece to a tip of the optical fiber cable,
a work station at an upstream side than the mounting station is used as a pulling station that pulls out the optical fiber cable from the case by a predetermined length, and includes a pulling section that causes the cable holding section to hold the optical fiber cable, and
the mounting station mounts a work piece to a tip of the optical fiber cable held by the cable holding section.

2. The optical fiber cable processing apparatus according to claim 1, wherein the cable holding section includes a base provided in the case holding part and a cover detachably provided to the base,
a cover attaching/detaching section that attaches/detaches the cover to/from the base is provided in the work station that includes the pulling section, and
the pulling section pulls out the optical fiber cable from the case and places the optical fiber cable on the base, the cover attaching/detaching section mounts the cover to the base, and the base and the cover sandwich the optical fiber cable.

3. The optical fiber cable processing apparatus according to claim 2, wherein at least one station between the mounting station and the pulling station is used as a coating removal station that removes a coating material at an end portion of the optical fiber cable and exposes the optical fiber to an outside part by a predetermined length,
a cover pressing section that presses the cover of the cable holding section toward the base is provided in the coating removal station, and
the cover pressing section presses the cover to hold the optical fiber cable while the coating removal section removes coating.

4. The optical fiber cable processing apparatus according to claim 2, wherein a part to be engaged is formed in the cover of the cable holding section,
the cover attaching/detaching section includes a gripper that holds the cover, and an engagement part to be engaged with the part to be engaged of the cover, and
the cover attaching/detaching section holds the cover with the gripper after engaging the engagement part with the part to be engaged of the cover, and in the state, the cover attaching/detaching section attaches/detaches the cover to/from the base.
